(19) United States
(12) Patent Application Publication
(10) Pub. No.: US 2006/0145691 A1
(43) Pub. Date: Jul. 6, 2006

(54) Ferromagnetic detection pillar and variable aperture portal

(75) Inventors: R. Kemp Massengill, Leucadia, CA (US); Frederick J. Jeffers, Escondido, CA (US); Richard J. McClure, San Diego, CA (US)

Correspondence Address: GERALD W. SPINKS, P. O. BOX 5242, GLACIER, WA, 98244, US

(73) Assignee: MedNovus, Inc., Leucadia, CA (US)

(21) Appl. No.: 11/060,069

(22) Filed: Feb. 16, 2005

Related U.S. Application Data
(60) Provisional application No. 60/640,337, filed on Dec. 30, 2004.

(51) Int. Cl. G01B 7/30

(52) U.S. Cl. 324/207.25

(57) ABSTRACT

A ferromagnetic detection pillar having one or more applied magnetic field sources and one or more magnetic field sensors, with the magnets and sensors arranged and adapted to detect a ferromagnetic threat object on any side of the pillar. A single free-standing pillar can be used to provide protection in an MRI facility, or two or more free-standing pillars can be arranged to constitute a variable aperture detection portal. Single sensors or multiple-sensor configurations can be used.

### CROSS REFERENCE TO RELATED APPLICATIONS

This application relies upon U.S. Provisional Patent Application No. 60/640,337, filed on Dec. 30, 2004, and entitled “Ferromagnetic Detection Pillar and Variable Aperture Portal.”

### STATEMENT REGARDING FEDERALLY SPONSORED RESEARCH OR DEVELOPMENT

Not Applicable

### BACKGROUND OF THE INVENTION

1. Field of the Invention

This invention is in the field of apparatus used to detect the presence of ferromagnetic threat objects to prevent the objects from being transported into the vicinity of a magnetic resonance imaging (MRI) magnet.

2. Background Art

Large ferromagnetic threat objects can be devastating when subjected to the strong magnetic field of a magnetic resonance imaging magnet. Pipe wrenches, floor scrubbers, oxygen cylinders, and even gurneys have been attracted to the MR magnet, as if propelled by a rocket, with disastrous consequences. At least one tragic death has occurred when a steel oxygen cylinder became, in effect, a lethal weapon. The problem is compounded when one considers the fact that many new MRI magnets have a much higher field of 3.0 Tesla (30 KOe). It is, therefore, prudent to screen people for such objects to prevent possible accidents.

Common metal detector portals, such as those used in airports, detect any metal. Hence they produce many false positive readings arising from coins, etc., that are non-magnetic, and, therefore, present no danger in the MRI setting. Ferromagnetic detection portals are very useful for ferromagnetic threat detection relative to a person or object passed through the portal. Nevertheless, disadvantages are present. First, ferromagnetic detection portals tend to be quite expensive, as these generally contain sensing elements, and other elements, on both sides of the portal, and, thus, these portals may be beyond the budget of some MRI centers.

Second, the side structures of these portals, when taken together, consume a significant surface area. This can be a major problem in a compact MRI center, such as a mobile truck. Indeed, in most mobile trucks, many ferromagnetic portals simply will not fit because of lack of room.

Many portals which are fixed in size are either too small, such as 25 inches, and thus unable accommodate a patient on a standard 28-inch gurney, or too large, and thus unable to squeeze into the restricted available space.

In addition, some portals are designed such that threats trigger an alarm only when the portal is turned on, and they typically trigger only when a ferromagnetic object traverses through the pass-through aperture of the portal. With such a portal, it is entirely possible that a significant ferromagnetic threat, such as a floor scrubber, could be introduced into the magnet room itself, because these large threat objects may not fit readily through the portal's screening aperture, which is required in order to trigger the portal's motion detection and alarm systems.

A naive orderly or technician may then decide to circumvent the portal's aperture completely, or, alternatively, simply omit turning on the portal. When the magnet room is entered with the threat object, a disaster can occur.

An interesting situation is when a magnetic resonance imaging center uses a ferromagnetic detection portal, but size constraints of the ante-room mandate that the portal be located elsewhere within the MRI center, such as in a different room completely. In this situation, a floor scrubber, or a metallic gurney, both of which constitute major threats, easily could be brought into the ante-room adjacent to the magnet room, where no ferromagnetic detection is available, and then catastrophically introduced into the magnet room.

Placing a ferromagnetic detection system on the door of the magnet room itself would theoretically avoid these risks, by requiring screening of every person, before entering the magnet room, but this is a doubtful proposition at best. By the time the alarm is triggered, the threat is already within the magnet room and, therefore, subject to the large magnetic field and gradient of the MRI magnet. So, placing a detector system on the door of the magnet room is a poor solution to the problem of some threats bypassing the detector system. If detection occurs in such a system, it is simply too late. Placing a ferromagnetic detection system on the door leading into the anteroom could be effective, but, if there are multiple doors leading to the ante-room, it is generally impractical to alarm all of these doors.

### BRIEF SUMMARY OF THE INVENTION

The preferred embodiment of the present invention is a free-standing ferromagnetic detection column or pillar. A single free-standing column or pillar can be used to screen the surrounding area, or two or more free-standing pillars can be arranged in the area as desired, constituting a variable aperture portal. The ferromagnetic detection pillar of the present invention provides a solution for the confined area application, as the pillar can be placed in a very confined area, such as a mobile truck.

The present invention, providing a single ferromagnetic detection pillar, or, alternatively, a variable aperture portal comprised of two or more ferromagnetic detection pillars, offers a solution to the space problem encountered in certain MRI centers. A novel aspect of the variable aperture portal is that its aperture can be adjusted at will by the MRI center, giving great flexibility, especially when an MRI center's floor plan is cramped. So, the use of two pillars to form a portal of variable aperture is a significant advantage over a fixed aperture portal.

Another advantage is realized whenever the portal is in one location for a period of time, and then moved to another location of different physical dimensions. When the variable aperture portal is moved, it can be configured with a different aperture than that employed in its original location. So, the variable aperture portal formed by two pillars which are not physically connected (free-standing) gives enormous flexibility in the size of the pass-through aperture desired, which can be adjusted depending upon the space requirements of that particular location.

Unlike some ferromagnetic portals, which are ready for ferromagnetic threat detection only when a switch is activated, the present invention is preferably always sensing, and is always in a ready-to-alarm mode. Thus, when a ferromagnetic threat is identified, an alarm is always triggered. The sensitivity may be modified, however, so that nuisance alarms are minimized. Certainly, major threats, such as wrenches, cell phones, floor scrubbers, oxygen tanks, wheelchairs, and gurneys, should be detected.

The preferred embodiment of the pillar of the present invention senses ferromagnetic threat objects, and subsequently triggers an alarm, regardless of whether an object is on one side or the other of the pillar. When two pillars form a variable aperture portal, an alarm is triggered, in the preferred embodiment, if a threat object passes through the portal's aperture, or is on one side or the other of either pillar column forming the portal. Unlike current ferromagnetic detection portals, which are not intended to alarm on threats other than those passing through the portal's aperture, a significant advantage of the present invention is that alarms occur whenever a ferromagnetic threat object is identified in the vicinity, regardless of its location on one side or the other of the pillar, or, in the case of two pillars forming a variable aperture portal, regardless of whether the threat is passing through the pass-through aperture or is outside the aperture. The alarm preferably has both visual components, such as one or more lights, and auditory components.

The present invention preferably will be configured such that a gradiometer configuration will be used for the sensors to decrease threat alarms from distant unwanted sources, such as moving elevators, or cars moving in a parking garage. In the gradiometer configuration, each sensor receives essentially the same signal from a distant source, and, therefore, no alarm is triggered by distant ferromagnetic threat objects, because of the absence of a differential, from one sensor to the other, in the received magnetization signal.

Alternatively, a single sensor configuration can be used. In fact, this configuration has the advantage of better sensing capability than a gradiometer configuration, with the disadvantage that more distant ferromagnetic threats are detected. In the MRI center which does not have extraneous distant sources of ferromagnetic material which trigger unwanted false alarms, such as caused by moving elevators, or cars in an underground parking garage or moving on a street in close proximity, the single sensor is actually preferable because it achieves better detectability.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a graph illustrating the degree of magnetization of an object versus the magnitude of the applied magnetic field;

FIG. 2 is a graph showing the magnitude of the applied magnetic field versus distance from the source;

FIGS. 3A and 3B illustrate the conceptual difference between a prior art detection portal and the detection pillar according to the present invention;

FIG. 4 illustrates the difficulty associated with the limited width of a prior art detection portal;

FIG. 5 illustrates the difficulty in protecting the magnet room from threat objects with a prior art detection portal;

FIGS. 6A and 6B illustrate two alternative positioning configurations for the detection pillar of the present invention;

FIG. 7A is a schematic perspective view of the arrangement of magnets and sensors on the pillar of the present invention;

FIG. 7B is a schematic top plan view of the magnetic field generated by the pillar shown in FIG. 7A;

FIGS. 8A and 8B show two alternative spacing configurations of the pillar of the present invention;

FIG. 9A is a schematic side elevation view of a pillar of the present invention with multiple sensor groups; and

FIG. 9B is a schematic side elevation view of a pillar of the present invention with a single sensor group.

### DETAILED DESCRIPTION OF THE INVENTION

The preferred location for the present invention, either a single free-standing pillar or a variable aperture portal configured with two free-standing pillars, is within the ante-room to the magnet room of an MRI center, preferably four feet or so from the door to the magnet room. Alternatively, the pillar or pillars can be placed elsewhere in an MRI center. It is imperative that the ante-room be as free or “clean” as possible of ferromagnetic threats. The present invention greatly decreases the possibility of a major ferromagnetic threat escaping identification and then entering the magnet room. So, in an application where a currently known type of ferromagnetic detection portal does not fit in the ante-room because it is too large, the single column pillar, or the variable aperture portal, of the present invention is an effective alternative solution. Aperture spacing in the present invention is as desired by the operator of the MRI center.

In the preferred embodiment of the present invention, be it a single pillar or a variable aperture portal, a connection to an automatic door interlock precludes entry to the magnet room when an alarm is triggered. In the ante-room location, the present invention functions as a “last resort” ferromagnetic detection alarm, intended to prevent potential catastrophic accidents, such as when pipe wrenches, floor polishers, wheelchairs, and even ferromagnetic gurneys enter the magnet room.

The present invention is intended to be “on” all the time, and, it is intended to alarm on all sides of the pillar or column or columns, even if a variable aperture portal has been configured. Therefore, it is quite difficult to circumvent, either intentionally or inadvertently.

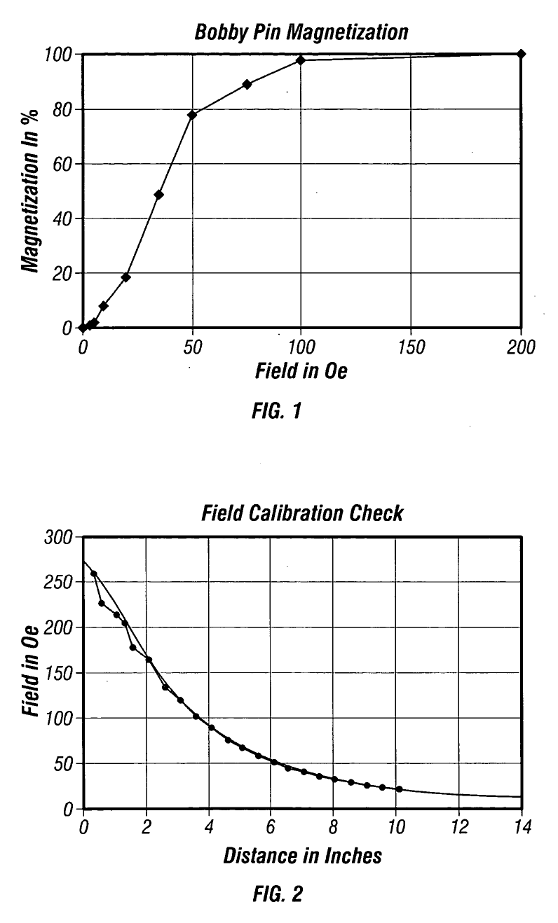

Existing ferromagnetic threat screening portals often depend upon the earth's magnetic field to magnetize target objects. Many common small ferromagnetic objects, such as bobby pins and paper clips, are scarcely magnetized by the small earth's field, roughly 0.5 Oe. FIG. 1 shows the magnetic moment induced in a bobby pin plotted versus a magnetic field applied parallel to the length of the pin. The bobby pin magnetization in the earth's 0.5 Oe field is only about 0.15% of saturation. The fringing field of the MRI magnet itself, typically 0.5 to 5 Oe, also yields poor induced magnetization, rendering detection quite difficult.

Detection of ferromagnetic threat objects is considerably facilitated if a moderate magnetic field of, say, 25 Oe is provided by magnetization means. A magnetic field of 25 Oe or so, giving a bobby pin magnetization of about 30%, increases the moment of the bobby pin target by a ratio of about 30% divided by 0.15%, or 200 times. Large threats are also better detected, especially at a distance from the sensors, if a magnetizing applied field is employed. As detectability is based, among other considerations, upon the level of induced magnetization of a threat object, applying an appropriately-sized independent magnetic field greatly increases detectability.

The strength of the magnetic field of a magnetized object is inversely proportional to the cube of the distance from the object. In other words, a factor of two increase in the distance results in a factor of eight decrease in the signal field. The pillar ferromagnetic detector of the present invention uses its own magnetization means because of this fact. The preferred embodiment uses permanent magnets, although magnetic ferrite strips, or coils, may be utilized. The magnetic fields of the magnets on the pillar or pillars are oriented in the same direction, to make the largest distant magnetic field possible, thereby increasing detectability.

FIG. 2 shows a calculated magnetic field plot for the pillar of the present invention, utilizing four inch by six inch magnets.

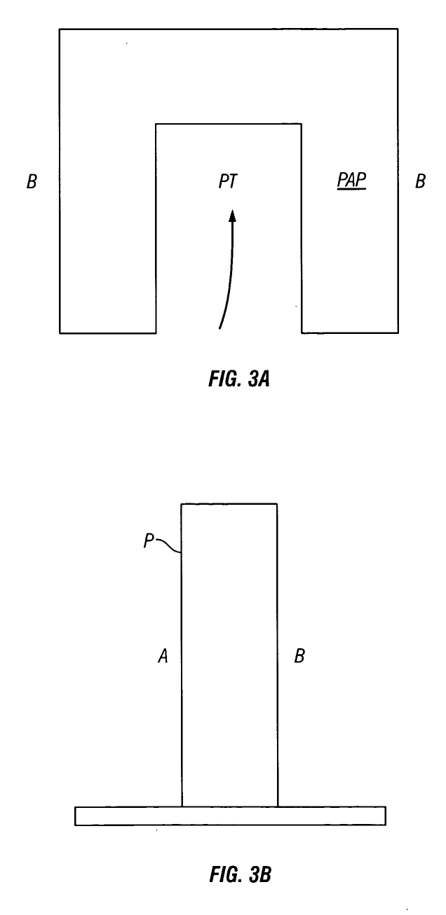

FIG. 3A shows a ferromagnetic detection portal PAP according to the prior art, where detection is intended to occur in the pass-through aperture area, indicated by PT, but not outside this area, indicated by B. Additionally, in an effort to minimize alarms when not in use, many ferromagnetic detection portals alarm only when a “ready” switch is activated manually by the technician. The portal is “off” during other times. FIG. 3B shows the pillar P of the present invention, in which the preferred embodiment alarms on ferromagnetic threats on both sides of the pillar, indicated by both A and B. Although not preferred, a pillar could be adapted to alarm on only one side, activated by a motion-sensing detector, or a heat detector, while ignoring signals from the other side, utilizing appropriate software to accomplish this.

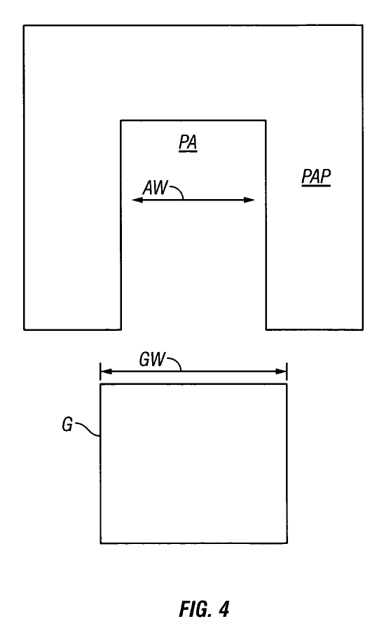

FIG. 4 demonstrates a prior art ferromagnetic portal PAP with a portal aperture PA. The typical such portal might have an aperture width AW of, for instance, 25 or 26 inches, which is insufficient to accommodate a patient on a typical gurney G with a gurney width GW of 28 inches. A pillar or variable aperture portal, according to the present invention, solves this problem.

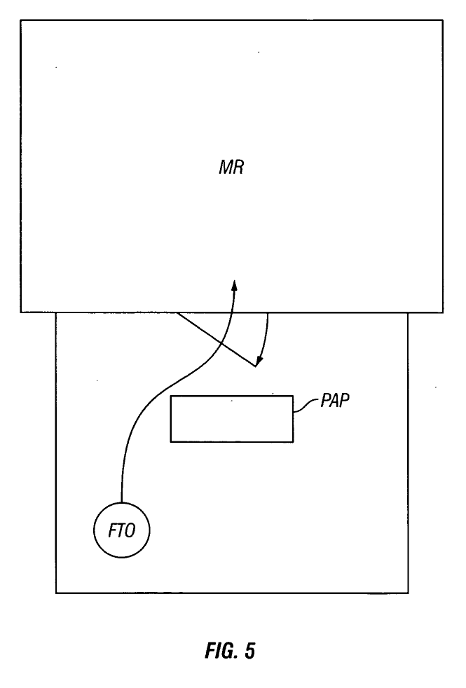

FIG. 5 shows a magnetic resonance imaging center floor plan, where it is apparent that a prior art ferromagnetic portal PAP can be bypassed by a ferromagnetic threat object indicated by FTO, allowing entrance into the magnet room itself, indicated by MR.

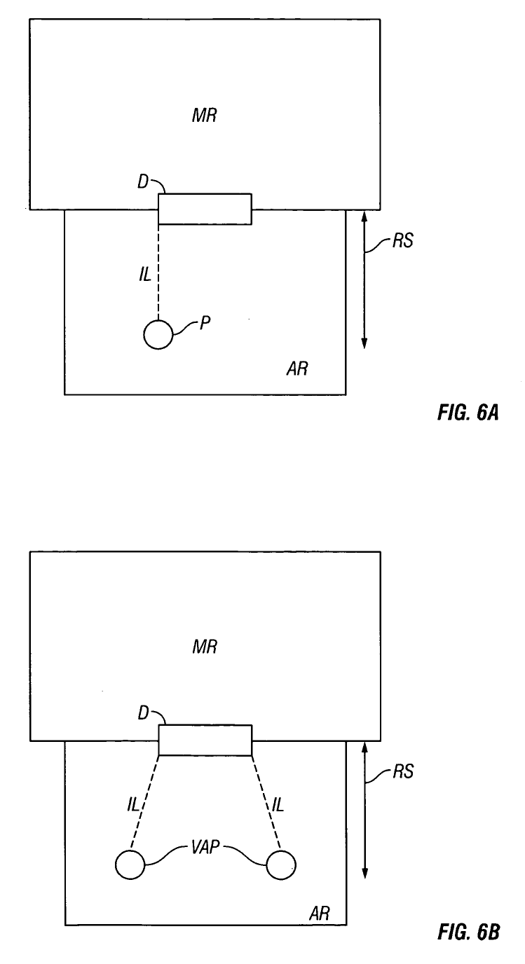

FIG. 6A shows the pillar P of the present invention in an ideal placement in the ante-room AR of the magnet room MR, namely, located a recommended spacing RS of approximately four feet from the doorway leading into the MR magnet room. Preferably, an interlock to the magnet room door D is provided, indicated by the dashed line labeled IL, which automatically locks, should a ferromagnetic threat be detected. The present invention, then, functions as a “last resort” major threat alarm system before the magnet room is entered.

FIG. 6B shows two pillars according to the present invention, forming a variable aperture portal, labeled VAP, in an ideal placement in the ante-room AR of the MR magnet room, located a recommended spacing RS of approximately four feet from the doorway. Note that these free-standing pillars can be placed at the discretion of the MR center managers, as there is no physical structure locking one pillar to the other, as would be the case with a prior art portal. The width of the aperture can be varied easily because of lack of structure between the two pillars. Preferably, an interlock from each pillar of the variable aperture portal VAP to the magnet room door precludes a ferromagnetic threat object from entry into the magnet room.

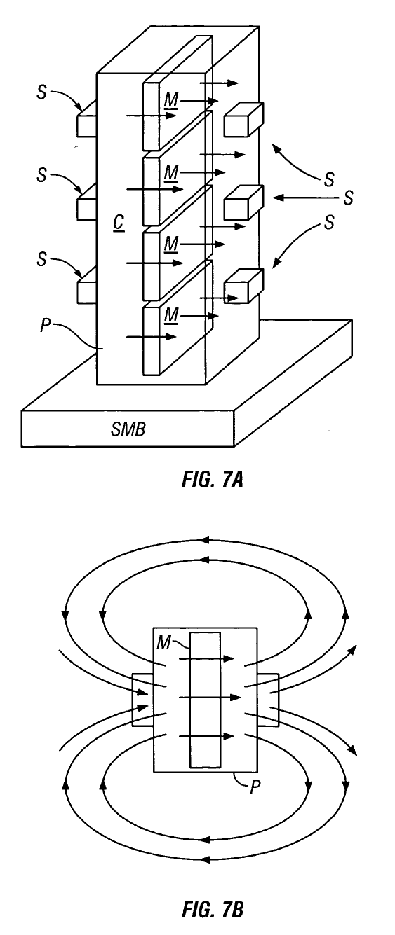

FIG. 7A shows the pillar P of the present invention, with a shock-mounted base SMB to minimize vibration, a column C extending to the desired height, such as 3 to 6 feet, at least one sensor, or multiple-sensor configuration, S, and magnetizing means, preferably permanent magnets M. Another embodiment can be made much shorter, if the intent is simply to detect large ferromagnetic threat objects, such as floor scrubbers. In most MRI centers, however, a height limitation is not usually required. When two pillars P are used to configure a variable aperture portal, the applied field magnetization, indicated by the arrows, is oriented in the same direction for both pillars, as this achieves the largest distant magnetic field and thereby increases the detectability of a ferromagnetic threat object. If the applied fields of the two pillars were to be oriented in opposite directions, undesirable cancellation of the magnetic field in the center of the variable aperture portal would occur. FIG. 7B is a top view of one pillar P, showing representative magnetic field lines from the magnets M.

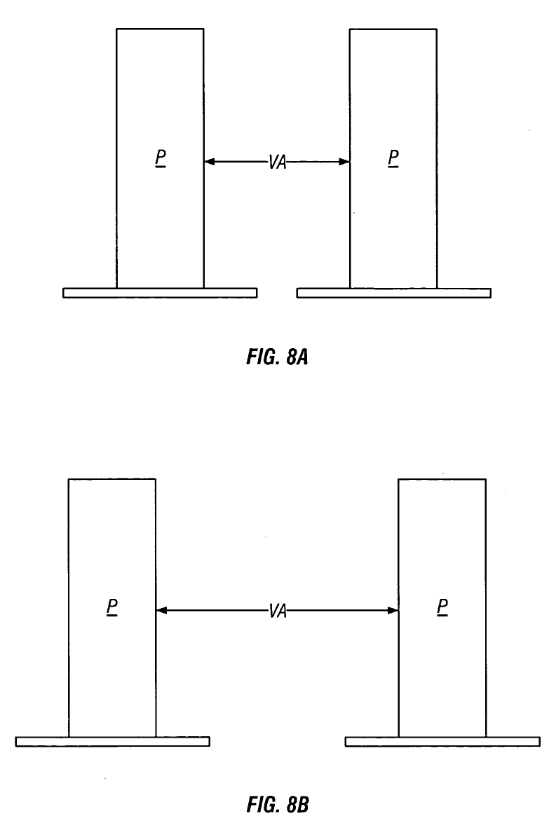

FIG. 8A and FIG. 8B show a variable aperture portal constituting two free-standing pillars P, demonstrating that the width of the variable aperture VA can be adjusted at will by the operator of the MRI center. If the variable aperture portal is moved, for instance, it can be configured with a different aperture than that employed in its original position.

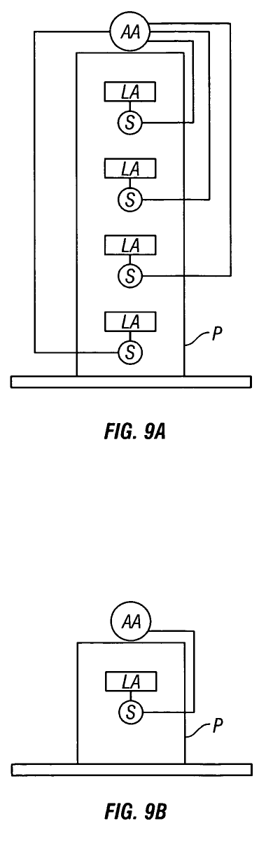

When more than one sensor or multiple-sensor configuration S is utilized for a pillar, location of the threat object can be achieved and displayed, via the use of appropriate software. As shown in FIGS. 9A and 9B, however, location of the threat object can be done less expensively, by having each sensor or multiple-sensor configuration S associated with that pillar P connected to its own independent light alarm system LA, with the light alarm system being located in close proximity to the associated sensor or multiple-sensor configuration. When a particular sensor or multiple-sensor configuration detects a threat object, the light alarm associated with that sensor or multiple-sensor configuration is triggered, giving an approximate height location for the ferromagnetic threat object. All sensors or multiple-sensor configurations on the pillar can be connected to a single auditory alarm AA, however, as dedicated auditory alarms are not needed.

The present invention employs independent magnetizing means to create an applied field. This is preferably via permanent magnets, or, alternatively, via magnetic ferrite strips, or coils. The sensors of each multiple-sensor configuration are preferably mounted in a gradiometer configuration about the magnetizing means, such that unwanted signals from distant noise sources tend to be rejected. In a gradiometer configuration, after appropriate balancing, each sensor “sees” the same magnetic field, and, if that field on both sensors is the same, a null reading occurs. This is desirable for maximal rejection of signals from distant sources, such as elevators, moving cars in the parking lot, and the like. On the other hand, in MRI centers which do not have extraneous sources of ferromagnetic material in the immediate environs (such as an MRI center lacking elevators, moving cars in the vicinity, etc.), the sensor preference can be one or more single sensors, as this increases detectability when compared to a gradiometer configuration. The gradiometer configuration will generally be employed, however, because most MRI centers, in reality, do have significant ferromagnetic objects outside the room in which the pillar or variable aperture portal is placed. It is absolutely desirable to detect ferromagnetic threat objects in the room in which the present invention is positioned, but generally undesirable to detect ferromagnetic threats at a distance from that room, as these constitute false alarms.

Unlike a prior art ferromagnetic detection portal, where it is undesirable to detect outside the portal's pass-through aperture, however, the single pillar and the variable aperture portal of the present invention detect on both sides of the pillar, or on both sides of each pillar in the case of the variable aperture portal. This aids in the search for ferromagnetic threats in the immediate vicinity, such as oxygen cylinders, floor scrubbers, and tools such as pipe wrenches. As the pillar is not generally intended to detect truly tiny objects, but, rather, major ferromagnetic threat objects on a “last resort” basis, one sensor or multiple-sensor configuration per pillar can certainly suffice in the most basic embodiment of the present invention. In the preferred embodiment, however, 3 to 6 sensors or multiple-sensor configurations S are used, preferably in gradiometer configuration, and these are spaced appropriately apart and are mounted upon the vertical column of the pillar.

The sensors can be of the usual varieties, including, but not limited to, magneto-resistive, fluxgate, Hall sensors, ferrite rod sensors, a large induction coil, magneto impedance sensors, etc. The preferred sensor, however, is a nonsaturable sensor, since this sensor type has high sensitivity and a large dynamic range. This allows the sensor to be placed in close proximity to the applied field magnetizing source, preferably magnets, and still retain high sensitivity. The described configuration of the preferred embodiment has the result that objects are sensed, and an alarm triggered, by threat objects on both sides of the pillar. The present invention, then, is ideal for placement in the ante-room to the magnet room, the last resort for meaningful ferromagnetic detection.

As use of only the earth's magnetic field, or the MRI fringing field, for magnetization of the threat object is inadequate, the present invention utilizes its own magnetizing means. The preferred embodiment utilizes permanent magnets, although magnetic ferrite strips or coils may alternatively be used, and the magnets preferably consist of four barium ferrite ceramic magnets, each 4 inches wide by 6 inches long by one inch thick. As shown in FIG. 2, such a magnet generates a magnetic field strength of about 90 Oe at 5 inches, 10 Oe at 15 inches, and 5 Oe at 20 inches. The 5 Oe field is 10 times higher than the earth's field of about 0.5 Oe. Clearly the distance at which a threat object can be detected depends on how much magnetic material the threat object contains. The larger the target, the farther away it can be sensed.

Because of the large magnetic field in the pillar, detection sensors with a wide dynamic range and high sensitivity are desirable. Nonsaturable magneto-resistors are well suited for this application, and they are used in the preferred embodiments of the threat detection pillar and the variable aperture portal.

In many MRI centers, the use of a large and expensive portal may be appropriate. A challenging situation, however, is when a large steel building frame member exists on one side of the entrance to the MRI room. This can affect the performance of the portal's sensors which are very close to the frame member. In these instances, the present invention's free-standing detection pillar, located on the opposite side of the entrance from the frame member, may provide a better solution to the ferromagnetic object screening problem of that particular MRI center.

An array of several sensors or multiple-sensor configurations maximizes the chances that a small target object will be close enough to a sensor to be detected. In the case of the pillar of the present invention, the use of an array of sensors or multiple-sensor configurations is preferred, but, alternatively, in cases where only large targets, like floor scrubbers, are to be detected, a single sensor or multiple-sensor configuration located near the floor is all that is required. Likewise, in the most basic embodiment of the present invention, a single sensor or multiple-sensor configuration can be utilized for each of the pillars configuring the variable aperture portal.

The preferred embodiment is to employ 3 to 6 sensors or multiple-sensor configurations for each pillar, and employ the multiple-sensor configurations in a gradiometer sensor configuration. The preferred sensor is a nonsaturable magneto-resistive sensor.

This disclosure is merely illustrative of the preferred embodiments of the invention and no limitations are intended other than as described in the appended claims.

We claim:

1. An apparatus for detecting a ferromagnetic threat object, comprising:
a free-standing pillar;
at least one applied magnetic field source mounted on said pillar;
at least one magnetic sensor mounted on said pillar; and
at least one alarm device;
wherein said at least one sensor is adapted to detect the magnetization of a ferromagnetic threat object by said magnetic field source; and
wherein said at least one sensor is adapted to activate said at least one alarm device upon detection of a threat object.

2. The apparatus recited in claim 1, wherein said at least one sensor is adapted to detect a threat object on either side of said pillar.

3. The apparatus recited in claim 1, wherein said at least one sensor is mounted as a part of at least one multiple-sensor configuration.

4. The apparatus recited in claim 3, further comprising a plurality of said multiple sensor configurations mounted on said pillar.

5. The apparatus recited in claim 4, wherein each said multiple-sensor configuration is configured as a gradiometer.

6. The apparatus recited in claim 3, wherein said at least one multiple-sensor configuration is configured as a gradiometer.

7. The apparatus recited in claim 1, wherein said at least one sensor is adapted to resist saturation by an applied magnetic field, thereby enabling said at least one sensor to retain high sensitivity when located in close proximity to an applied field magnetizing source.

8. The apparatus recited in claim 1, further comprising a door interlock, wherein said at least one sensor is further adapted to activate said door interlock upon detection of a threat object.

9. The apparatus recited in claim 1, further comprising a plurality of said free-standing pillars, said pillars being spaced apart to establish at least one aperture therebetween for passage of a potential threat object.

10. The apparatus recited in claim 9, wherein said applied magnetic field sources on said plurality of pillars are arranged with their magnetic field axes substantially parallel to each other and oriented in substantially the same direction.

11. The apparatus recited in claim 1, further comprising a plurality of said magnetic sources on said pillar.

12. The apparatus recited in claim 1, further comprising a plurality of said sensors on said pillar.

13. The apparatus recited in claim 12, further comprising a plurality of said alarm devices mounted on said pillar, wherein each said at least one sensor has at least one said alarm device associated therewith.

14. The apparatus recited in claim 13, wherein said plurality of alarm devices comprise visible alarms.

15. The apparatus recited in claim 1, wherein said at least one alarm device comprises a visible alarm.

16. The apparatus recited in claim 1, wherein said at least one alarm device comprises an audible alarm.

17. A method for detecting a ferromagnetic threat object, comprising:
providing a free-standing pillar having at least one applied magnetic field source and at least one magnetic sensor;
providing at least one alarm device;
detecting the magnetization of a ferromagnetic threat object by said magnetic field source, with said sensor; and
activating said at least one alarm device upon detection of a threat object by said sensor.

18. The method recited in claim 17, further comprising detecting any threat object which may be present on either side of said pillar with said sensor.

19. The method recited in claim 17, further comprising:
providing a door interlock; and
activating said door interlock upon detection of a threat object by said sensor.

20. The method recited in claim 17, further comprising;
providing a plurality of said free-standing pillars;
spacing said pillars apart to establish at least one aperture therebetween for passage of a potential threat object; and
detecting the magnetization of a ferromagnetic threat object passing through said aperture, with said sensor.

21. The method recited in claim 20, further comprising arranging said applied magnetic field sources on said pillars with their magnetic field axes substantially parallel to each other and oriented in substantially the same direction.
